(19) United States
(12) Patent Application Publication
(10) Pub. No.: US 2003/0033351 A1
(43) Pub. Date: Feb. 13, 2003

(54) Group proxy and method for grouping services in a distributed computing application

(76) Inventor: Aleta Ricciardi, West Windsor, NJ (US)

Correspondence Address: Stuart D. Rudoler, Wolf, Block, Schorr and Solis- Cohen, LLP, 22nd Floor, 1650 Arch Street, Philadelphia, PA, 19103-2097, US

(21) Appl. No.: 09/928,028

(22) Filed: Aug. 10, 2001

(51) Int. Cl. G06F 15/16

(52) U.S. Cl. 709/202

(57) ABSTRACT

A distributed computing system with an improved architecture and methodology which is capable of handling a wide range of dynamic groups of services where the makeup of the groups can be determined and changed while the application is running. This is mainly accomplished through a group proxy, which is generated at run time, and which handles interactions with groups of services on behalf of one or more clients. The group proxy consists of a group logic shell which contains all the group-aware logic, and a service proxy for each service in the group which contains the necessary logic to interact with the particular service. A grouping agent is also described which provides the group-aware logic for each service that participates in a group, as well as a group service which generates and updates the group proxy. The group service dynamically creates the group proxies for each group by adding the appropriate service proxies to a group logic shell and then registers the group proxies with a look-up service for use by clients. In the preferred embodiment of the invention, all the group-aware logic for a distributed computing application is provided in separate code modules, namely the group proxy, group service and grouping agent, thus relieving clients and services from providing this logic.

### BACKGROUND OF THE INVENTION

A distributed system is a collection of autonomous computing entities, hardware or software, connected by some communication medium. While often the computing entities are geographically dispersed, in some instances they might be separate processors in a multi-processor computer or even separate software routines executing in logically isolated memory space on the same computer. A computing entity need not be a traditional computer, but more generally can be any computing device, ranging from a large mainframe to a refrigerator or a cell phone. A distributed application is an application that executes on a distributed system and one in which parts of the application execute on distinct autonomous computing entities.

Whenever a distinct component of a distributed application requests something (e.g., a data value, a computation) of another component, the former is called a client and the latter is called a service. It is worth noting that the terms service and client are not exclusionary in that an item can be both a client and a service. For example, a routine that calculates the time between two events may be a client and of a clock service; if the clock service then calls a routine that converts to Daylight Savings Time, the clock becomes a client and the Daylight Savings Time converter is its service.

FIG. 1 shows a typical distributed application of the existing art. There are two clients 2, 4 and four services 10, 12, 14, 16 that the clients 2, 4 might need. Each service has a service proxy 10a, 12a, 14a, 16a which is a module of mobile code that can be used by clients to invoke that service. A service proxy 10a, 12a, 14a, 16a contains the code needed by a client 2,4 to interact with a service. For instance if a service is a digital camera on a robotic arm, the interfaces might include Initialize( ), Zoom( ), Rotate( ) and Get_Picture( ). The service proxy 10a, 12a, 14a, 16a may also provide the expected return values for the service, which might include error codes as well.

Mobile code generally refers to a computer program that can be written on one platform and executed on numerous others, irrespective of differences in hardware, operating system, file system, and many other details of the execution environment. In addition to independence from the physical characteristics of the execution environment, a mobile program may move from one computer to another in the middle of its execution.

Mobile code may be pre-compiled, or compiled when it arrives at the execution platform. In the first case, numerous versions of the program must be written and compiled, then matched across run-time environments; this is mobile code in the letter, but not the spirit, of the definition. In addition, the same pre-compiled program cannot move from one platform to a different one during its execution. In the second, the program text may be distributed along with configuration scripts describing what to do in each execution environment. This distributes and delays the specificity of the pre-compiled option. The more interesting, and far more common approach exploits a standard virtual machine, which finesses all the issues of platform heterogeneity. The virtual machine is a program that itself mitigates the machine dependencies and idiosyncrasies, taking the raw program text and compiling it binary executable.

In addition to clients 2, 4 and general services 10, 12, 14, 16, all distributed applications need some mechanism for clients 2, 4 to find services. Often such knowledge is assumed a priori, but many distributed applications use a look-up service 20. The look-up service 20 is a service with which the other services are registered or advertised to be available to for use by clients. In a simple system, where there is no attempt to coordinate replicas of services, each new service registers with the look-up service 20 (in the case of replicas, the onus falls on the client to resolve conflicts and ambiguity). When a service 10, 12, 14, 16 registers, it provides information telling clients 2, 4 how to find it. Commonly, this is a physical location such as an IP address and port number, but in the most modem systems this can be as powerful as giving the look-up service 20 a service proxy 10a, 12a, 14a, 16a, which is actual mobile code that clients 2, 4 can execute and use to invoke that service 10, 12, 14, 16. In this way, the service proxy 10a, 12a, 14a, 16a contains not just location information but information for how to use the service 10, 12, 14, 16. While just as necessary for the client 2, 4 as location information, this has previously been assumed as a priori knowledge. When a client 2, 4 wishes to work with a service 10, 12, 14, 16 it finds it through the look-up service 20, downloads the service proxy 10a, 12a, 14a, 16a for that service 10, 12, 14, 16 from the look-up service 20, then uses the service proxy 10a, 12a, 14a, 16a to invoke the service 10, 12, 14, 16. The look-up service 20 may also have attributes of the services 10, 12, 14, 16, such as whether it is a grouped service, what type of group it is, what its cost to use is, how accurate it is, how reliable it is, or how long it takes to execute. In such cases the clients 2, 4 can use the attributes to decide which of a number of services 10, 12, 14, 16 it wishes to use.

Each of the foregoing has access to a communication network 22 so that it is capable of communicating with at least some of the other members in the distributed computing application. The communication network 22 may be wireless, a local area network, an internal computer bus, a wide area network such as the Internet, a corporate intranet or extranet, a virtual private network, any other communication medium or any combination of the foregoing.

In the prior art example shown in FIG. 1, one client 2 is a traffic monitoring program that notifies a user when and where traffic has occurred and the other client 4 is an automated toll collection program. The services are a clock 10, a road sensor 12 that monitors traffic flow on a highway, a toll booth sensor 14 that detects an ID device in each car that passes through the toll, and a credit card charge program 16. When each service 10, 12, 14, 16 becomes available to the application it registers with the look-up service 20 and provides the look-up service with its service proxy 10a, 12a, 14a, 16a.

When the traffic monitoring client 2 begins, it queries the look-up service to see if a clock is available and what sensors are available. The look-up service 20 responds by providing the client 2 with the clock proxy 10a, the road sensor proxy 12a and the toll booth sensor proxy 14a. The traffic monitoring client 2 uses the service proxies 10a, 12a, 14a to invoke the clock 10 and the sensors 12, 14, and then to monitor traffic at various times of the day.

Similarly when the toll collector client 4 begins, it queries the look-up service 20 to see if a toll booth sensor 14 and a credit card charge service 16 are available. The look-up service 20 responds by providing the client 4 with the toll booth sensor proxy 14a and the credit card charge proxy 16a. The toll collector client 4 uses the service proxies 14a, 16a to invoke the toll booth sensor 14 and the credit card charge program 16, and then to identify cars that pass through the toll booth and charge their credit cards for the toll.

A known feature of distributed applications is that services may be grouped. For instance there may be several services capable of performing the traffic sensor functionality. These can be grouped to form a logical notion of traffic sensor that is separate from the particular implementation of the sensors. This may be done for redundancy purposes in case one of the services fails, to provide parallel processing for computationally intensive tasks, to provide extra capacity for peak loads, as well as for many other reasons. Services in a group may communicate with each other to coordinate their activities and states. For instance in the example shown in FIG. 1 it may be advantageous to group the two sensors 12, 14.

There are two primary types of group structures: the coordinator cohort (CC) group and the peer group. In a CC group, there is one distinguished member of the group, the coordinator, that processes requests from clients. The coordinator periodically updates the other services in the group, the cohorts, with information about its current state and completed requests, so that if the coordinator fails, the cohort selected to replace it will be as current as possible. The more frequent the updates, the more tightly coupled the states are between group members, and so the more likely the transition will occur without being visible to existing clients of the group. On the other hand, more frequent updates require additional computational capacity and communication bandwidth.

In a peer group, all of the members of the group process requests from a client, which itself requires some logic to decide how to use the multiple results returned from the group members. For example, if three thermometers exist in peer group, and a client requests the temperature it will receive three answers. Many options exist for using the multiple results, such as taking the first to respond, taking the average value of all the responses, or taking the highest value. A peer group is more robust and fault-tolerant than a CC group because each of the group members should always be in the correct state, and because the likelihood of the representative member (which is all members in a peer group, but only the coordinator in a CC group) being unavailable is drastically lower. However, a peer group also requires more resources, both bandwidth and computational, than a CC group because all of the group members are working and responding to each client request.

Another technique known in the existing art is leasing. A lease is an important concept throughout distributed computing, generally used between a client and service as a way for the service to indicate its availability to the client for a length of time. At the end of the lease, if the lease is not renewed, there is no guarantee of availability. In a simple example, a service may register with a look-up service and be granted a lease for five minutes. This means that the look-up service will make itself available to the service (i.e., list it) for five minutes. If a camera grants a lease to a client for two minutes, then that client will be able to position, zoom, and take pictures for two minutes. There are a wide variety of ways to handle lease negotiation, renewal and termination which are well known to those skilled in the art of distributed computing and all such methods are meant to be incorporated within the scope of the disclosed invention. A detailed explanation of leases can be found in, Jim Waldo, The Jini Specification, 2nd Edition, chapter LE (2001), which is incorporated herein by reference.

One useful aspect of leases is that they can be used for simple failure detection. If the expectation is that a client will continue to request lease renewal from a service, but then does not renew its lease, the service may assume that the client has failed, or is otherwise unavailable. This allows the service to more efficiently manage its own resources, by releasing any that were dedicated to expired clients. Such a use of leasing is described in U.S. Pat. No. 5,832,529 to Wollrath et al.

This is especially important because components only rarely plan and announce their failure and are not able to predict network outages. It is far more common that failures and outages are unexpected, and that the consequence is an inability to announce anything. In these cases, a client will not renew its lease so that eventually, the granting service will reallocate its resources. The shorter the lease period, the sooner a failure can be detected. The tradeoff is that both client and service spend proportionately more time and resources dealing with leasing.

Some benefits of distributed computing and mobile code can immediately be seen from this example. First, the clients 2, 4 in FIG. 1 do not need to know ahead of time which sensors 12, 14 are available, or even how many. They simply query the look-up service 20, which provides this information along with the necessary mobile code 12a, 14a to call the sensors. Similarly, the clients 2, 4 do not care which clock 10 is available, as long as any clock 10 is available. Again, this is because through the use of mobile code, a client 2, 4 is provided with the necessary service proxy 10a to invoke and work with the clock 10. Also, the failure or unavailability of a single sensor 12, 14 or other service is not likely to cause the entire application to stop running. Further, the processing load is distributed among a number of computing devices. Also, the various computing entities need not use the same operating system, so long as they conform to a common interface standard.

Jini is one example of a commercially available specification for a distributed object infrastructure (or middleware) for more easily writing, executing and managing object-oriented distributed applications. Jini was developed by Sun Microsystems and is based on the Java programming language; consequently, objects in a Jini system are mobile. Jini is described in Jim Waldo, The Jini Specification, 2nd Edition (2001). The Common Object Request Broker Architecture (CORBA), developed by the Object Management Group, and Distributed Component Object Module (DCOM), developed Microsoft Corporation, are two other commercially available examples that are well known in the prior art. Jini, DCOM, CORBA and a number of other distributed computing specifications are described by Benchiao Jai et al., Effortless Software Interoperability with Jini Connection Technology, Bell Labs Technical Journal, April-June 2000, pp. 88-101, which is hereby incorporated by reference.

Distributed computing systems with groups can also be found in the prior art, particularly in the academic literature. For example, Ozalp Babaoglu et al., Partitionable Group Membership: Specification and Algorithms, University of Bologna, Department of Computer Science, Technical Report UBLCS-97-1 describe groups, but assumes the services in the group are group-aware. Similarly static group proxies, or software wrappers, for clients have been described in Alberto Montresor et al. Enhancing Jini with Group Communication, University of Bologna, Department of Computer Science, Technical Report UBLCS-2000-16, but these group proxies cannot be modified during execution of the distributed application to accommodate changes in group make-up and structure.

A number of problems can be found in these and other implementations and putative descriptions of distributed applications. Chief among these is that, even if some notion of groups is available within the infrastructure, both services and clients need to be group-aware; that is they need to contain logic to interact either within and as part of a group (in the case of grouped services), or with a group (in the case of clients of a group of services). This logic is very complex and the skill set required to write such software is very different from the skills required to write the underlying client or service. Further, many existing clients and services exist that do not have group logic, and even for clients and services that are being newly written it can be challenging to write this logic as part of the module. Even if group logic is coded into new clients or services, they become locked into a particular instance and type of group and in most cases will need to be rewritten if the group architecture of makeup changes. Therefore it is desirable to develop a methodology wherein the group-aware logic for clients and services are provided in separate code modules. Existing and previously described attempts at group services have always assumed that both the services to be grouped and the clients using group services are group-aware. The assumption of group-awareness prevents existing, or legacy, software from being able to take advantage of the benefits of groups (unless they are rewritten) and burdens new applications with providing the necessary group logic to operate with the particular implementation of the group service. All previous frameworks ignored clients. If wrappers were considered for grouping legacy services, they were static and hard-coded, locking the service into a single framework. Moreover, static wrappers introduce an additional, distinct point in the computation, with negative performance and, ironically, fault tolerance implications, since such solutions can never operate in the same process space. In all frameworks, group structures were static and therefore did not permit transitions between group structures.

Further, even if clients are written to be group-aware, they must be group-aware in the very particular way that the group of services are implemented. For example, if a client is capable of delaying its requests during membership changes to a group of services, until it receives a signal informing it that the membership change has completed, then it cannot interact with a system in which groups send no such signal, but instead expect the client to poll for this information. Therefore it would be preferable for this logic to be provided at run time when the groups are established.

Another problem that exists in current systems is that when new services are added to a distributed application either the distributed application must be stopped or the clients that call the service must be halted. It is desirable to have a distributed application in which new services can be added, or services in a group restructured, “on the fly”, that is without halting other members of the application.

It is therefore an object of this invention to provide a method for transparently managing and interacting with groups of services in a distributed application in which groups are dynamic in their membership, organizational structure, and their members' individual functionality.

It is a further object of this invention to provide a method of grouping services in which the group-aware logic is provided in separate code modules from the core functional logic of the clients and services.

It is a further object of this invention to provide a method of grouping services in which the code modules that handle the group-aware logic are highly reusable from one application to the next.

It is a further object of the invention to provide a method of grouping services in which the code modules that bundle group-aware logic are mobile and can be provided at run time.

It is a further object of the invention to provide for a method of grouping services where services can be added or removed, and groups restructured on the fly.

### Brief Description of the Invention

The present invention is a distributed computing system with an improved architecture and methodology which is capable of handling a wide range of dynamic groups of services where the makeup of the groups can be determined and changed while the application is running. This is mainly accomplished through a group proxy, which is generated at run time, and which handles interactions with groups of services on behalf of one or more clients. The group proxy consists of a group logic shell which contains all the group-aware logic, and a service proxy for each service in the group which contains the necessary logic to interact with the particular service. A grouping agent is also described which provides the group-aware logic for each service that participates in a group, as well as a group service which generates and updates the group proxy, and directs some of the grouping agent activities. The group service dynamically creates the group proxy for each group by adding the appropriate service proxies to a group logic shell and then registers the group proxy with a look-up service for use by clients. In the preferred embodiment of the invention, all the group-aware logic for a distributed computing application is provided in separate code modules, namely the group proxy, group service and grouping agent, thus relieving clients and services from providing this logic and maintaining the purity of the look-up service and other infrastructure services.

### BRIEF DESCRIPTION OF THE DRAWINGS

FIG. 1 shows an example of a distributed computing application of the prior art.

FIG. 2 shows an example of an improved distributed computing application of the current invention.

FIG. 3 shows a Foo service joining as the first member of a coordinator cohort group of Foos.

FIG. 4 shows a Foo service joining as the kth member of a coordinator cohort group of Foos.

FIG. 5 shows a client accessing a Foo coordinator cohort group.

FIG. 6 shows a fail-over from Foo-1 to Foo-2 in a coordinator cohort group FIG. 7 shows a Foo service joining as the first member of a peer group of Foos.

FIG. 8 shows a Foo service joining as the kth member of a peer group of Foos.

FIG. 9 shows a client accessing a Foo peer group.

FIG. 10 shows a generic representation of the current invention.

### DETAILED DESCRIPTION OF THE INVENTION

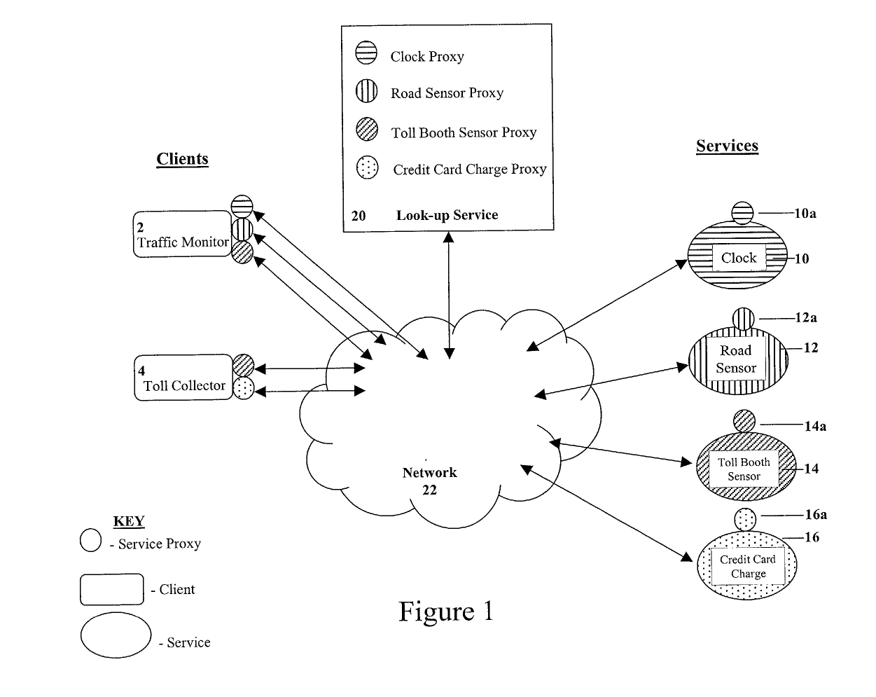

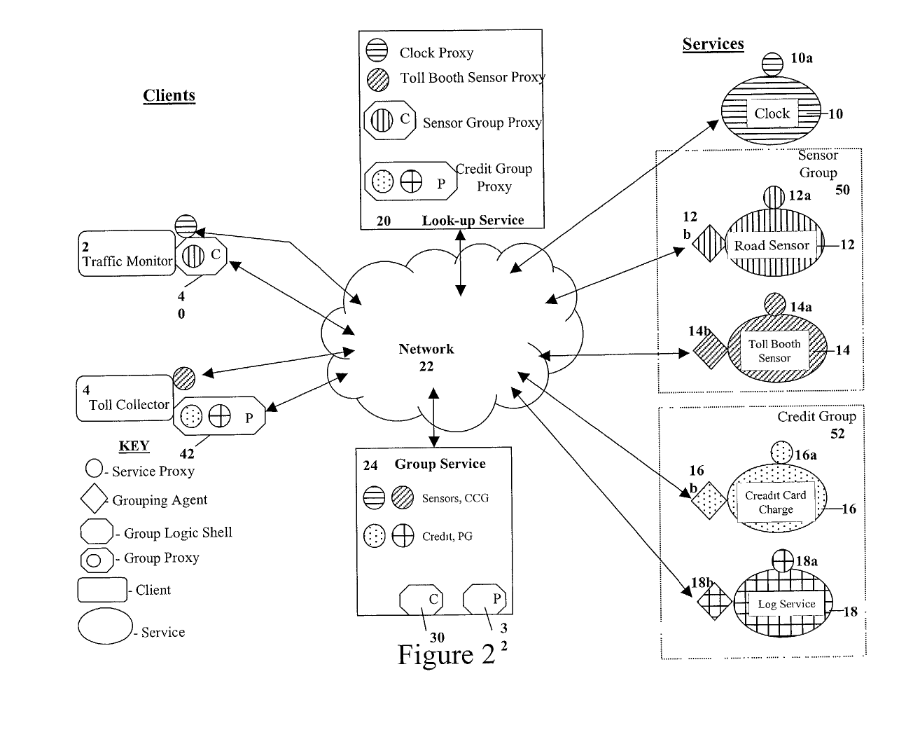

FIG. 2 shows an example of a distributed computing application of the current invention. As in FIG. 1 there is a communication network 22, a look-up service 20, a number of clients 2, 4, and a number of services 10, 12, 14, 16, 18, each of the latter having a service proxy 10a, 12a, 14a, 16a, 18a. In the current invention some of the services are grouped. In this example one group of services is a CC group 50 and the other group is a peer group 52. To support the group activity each grouped service is provided with a grouping agent 10b, 12b, 14b, 16b, 18b and there is a group service 24. In addition to there being proxies for each service there are also group proxies 40, 42, which act as proxies for each group.

The example shown in FIG. 2 provides specific clients services and groups, but the invention is generic in application and the example is not meant to limit the invention in any way.

### Overview

While the detailed workings of the present embodiment of the invention will be described below, a general introduction is provided here for this example. As in FIG. 1, the example of FIG. 2 is related to traffic monitoring and toll collection. An additional service, a log service 18, has been added which copies all information sent to it to some form of non-volatile memory. The log service 18 is essentially a recorder. The non-volatile memory might be a magnetic or optical medium, or even a paper print-out.

In this embodiment of the invention the road sensor 12 and the toll booth sensor 14 are grouped together in a CC group 50. As in FIG. 1 the traffic monitor client 2 makes calls to a clock 10, which is not grouped, and a sensor. However, in this example the sensor is grouped. From the point of view of the traffic monitor client 2, it does not need to know that the sensor is grouped, it simply calls a sensor service to get road traffic information, which in this case is a CC group 50. In the example the road sensor 12 is the coordinator and the toll booth sensor 14 is the cohort. If the road sensor 12 becomes unavailable, due to failure or any other reason, the toll booth sensor 14 will act as its backup and become the coordinator. The road sensor 12 might be designated as coordinator simply because it was the first to register with the group service 24, is more accurate, is more reliable, is less expensive or for any other reason.

The credit card charge service 16 and log service 18 are also grouped together, in this case as a peer group 52. Because they are grouped as a peer group, calls by any client to the credit group service 52 are executed by both the credit card charge service 16 and the log service 18. This is convenient in that a permanent record of charges is made by the log service 18 so that audits can be made to make sure that all credit charges executed by the credit charge service 16 were properly credited. In the event the credit card charge service 16 becomes unavailable, instead of failing, the credit group service 52, through the log service 18, at least creates a permanent record of charges, which can be retrieved later and processed.

### Grouping Agent and Group Service

An improvement of the current invention is the use of grouping agents 12b, 14b, 16b, 18b, to handle the group-aware logic for the grouped services 12, 14, 16, 18. It is the grouping agent that intercept a registration call from a service to the look-up service 20 and directs the call to the group service 24. It is also the grouping agents 12b, 14b, 16b, 18b, that handles coordination between the services in a group. If a service belongs to more than one group, it might have multiple grouping agents.

While in a new service being written from scratch the grouping functions performed by the grouping agent can be written as an integrated part of the service, it is preferable that the grouping agent be written as a distinct code module from the core functions (i.e., addition and subtraction in a calculator). This allows 1) the grouping agent to be modified without affecting the core, 2) the core to operate with numerous different (or no) grouping agents simultaneously, 3) the grouping agent code to be used with a variety of different services, in most cases, with only minor modification, and 4) grouping agents to be switched on the fly. In services that are not group-aware, a grouping agent can be added to the existing core to make the legacy service group-aware.

The invention further provides for a novel group service 24 which performs a variety of functions that facilitate groups in the application. All of the services that wish to be grouped register their service proxies with the grouping service 24 instead of the look-up service 20. More accurately, a service's grouping agent registers its service proxy with the grouping service.

However, for purposes of simplicity any group related activity described as taken by a service shall mean that the action is taken either by the service itself, if it is inherently group-aware, or by its grouping agent. The group service 24 then registers the appropriate service proxies with the lookup service 20. The group service 24 also coordinates whether each group will be a CC or peer group. Most importantly the group service 24 dynamically creates the group proxies 40, 42 for each group by adding the appropriate service proxy (in the case of a CC group) or proxies (in the case of peer group) 10a, 12a, 14a, 16a, 18a to the appropriate group logic shell 30, 32, and then the group service 24 registers the group proxies 40, 42 with the look-up service 20 for use by the clients 2, 4. The group service 24 also coordinates the activities of the group proxies 40, 42 during fail overs or other transitions and handles the updating of group proxies 40, 42 with the look-up service 20 and the various fielded (i.e. already attached to a client) group proxies 40, 42 when it is necessary to add, delete or switch the service proxies 10a, 12a, 14, 16a, 18a. The group service 24 also handles the swapping of group proxies 40, 42 if a group switches from CC mode to peer mode or vice versa.

### Group Proxy

The group proxy 40, 42 represent another improvement of the current invention. Its task, as each grouping agent does for its service, is to handle all the group-aware logic for its client. It can be thought of as a device driver for a group of services. In addition, and of particular importance, a grouping proxy can buffer or redirect communication to and from a client when the group that client is calling is in transition. Such a transition may occur due to a failure of a service in a group, the addition or removal of a service in a group, changing of coordinators in a CC group, or a group switching between CC and peer mode. Since the group proxy provides an easily configurable software layer between the client and the rest of the distributed application it can also be used to perform other useful tasks such as copying commands to a test service, resolving the results of multiple responses from a peer group of services, or copying communication to a log service.

The group proxy 40, 42 is made up of a group logic shell 30, 32 and one or more service proxies 10a, 12a, 14a, 16a, 18a. The group logic shell 30, 32 contains all of the necessary group logic for a client to interact with a group of services. Assuming there is a defined interface (e.g. syntax) to call a service, the group logic shell 30, 32 contains this interface to present to clients 2, 4. The group logic shell 30, 32 contains the logic to intercept client 2, 4 commands to a group 50, 52, store them, and retransmit the commands at a later time. The group logic shell 30, 32 may also contain logic to copy or redirect client 2, 4 communication to other services. However, the group logic shell 30, 32 does not contain the necessary logic to interact with the services 10, 12, 14, 16, 18 within a group. This logic is contained within the service proxies 10a, 12a, 14a, 16a, 18a. The group service 24 bundles the group logic shell 30, 32 with one or more service proxies 10a, 12a, 14a, 16a, 18a to form a group proxy 40,42.

As shown in FIG. 2, there are separate group logic shells for a CC group 30 and for peer group 32. In fact, in the current embodiment there are two group logic shells for each group, one peer and one CC. Although a large portion of the group logic shell code is the same from group to group, each group has its own shells because the group logic shell has to present the identical interface to the client as the any single member of the group would present. In an alternative embodiment, the group logic shells 30, 32 for each group stored within the group service 24 are identical, and when a group logic shell initializes it receives the necessary service interface from the grouping agents, or determines the appropriate interface using a process

known as reflection. Reflection is well known to those skilled in the art of distributed computing and mobile code, and will not be elaborated upon here. Since storage space is generally inexpensive and the executable code for the group logic shells is not unduly large, in the shown embodiment the group service 24 stores a set of two group shells, peer 32 and CC 30, for each group.

In an alternative embodiment, the peer and CC group logic shells 32, 30 are combined into a single mobile code module and the group service 24 simply tells the group proxy in which mode to act. Such an architecture has certain advantages when it is desirable to transition groups between CC and peer mode on the fly, since it is not necessary to switch group proxies or logic shells at the clients, and therefore it is easier to ensure that no client commands are dropped in transition.

The use of a group logic shell to form a group proxy is an improvement of the current invention. It makes it possible to create and reconfigure group proxies on the fly as the application is running. It enables an architecture where, in most cases, only service proxies in the group proxy need to be updated as services are added and deleted from a group, instead of replacing the entire group proxy. Alternatively, logic shells may be changed, perhaps to switch between peer and CC modes, without replacing the service proxies.

FIG. 2 demonstrates another improvement of the current invention, namely that the same service can be simultaneously grouped and ungrouped with respect to different clients. In FIG. 2 the traffic monitor client 2 calls the sensor group 50 which includes the toll booth sensor 14. Simultaneously, the toll both sensor 14 is called directly by the toll collector client 4. The difference is that the toll collector client 4 uses the toll booth sensor service proxy 14a directly, while the traffic monitor client 2 uses the sensor group proxy 40. As shown the road sensor 12 is the coordinator of the sensor group 50 so that the sensor group proxy 40 attached to the traffic monitor client 2 is bundled with the road sensor service proxy 12a. Although not shown, if the toll booth sensor 14 becomes the coordinator for the sensor group 50, the group service 24 would swap the toll booth sensor service proxy 14a for the road sensor service proxy 12a in the sensor group proxy 40 at the traffic monitor client 2. Then both clients 2, 4 could use the toll both sensor 14 simultaneously, assuming it had enough processing power and bandwidth to serve both. Such a configuration may require a more sophisticated grouping agent that is able to differentiate between calls to the group and calls directly to the service. In such a scenario it is also beneficial that the client querying the look-up service be able to establish whether a particular service is grouped or ungrouped.

The group service manages the membership and structure of groups of services, is responsible for registering each group with the look-up service when its composition and structure are stable, and de-registering it when these are in transition. By way of an example, if there are three distinct services that have indicated (possibly through a grouping agent) a desire to form a particular group, the group service might determine that the instance with oldest time stamp be the representative provided to the look-up service; upon monitoring that instance the group service might later determine that some other instance (e.g., with the next oldest time stamp) should replace it and be registered with the look-up service. The group service also provides group proxies and is responsible for alerting clients through the group proxies of transitions within a group. The group service may also determine into which group structure the services are organized.

In the present embodiment of the invention it assumed that all group members expose and implement the same external interface. This makes all services in a group appear to be identical, even if they are not exact replicas. For example, a group of calculators may each perform addition, subtraction, multiplication and division. Regardless of whether the calculators were true identical replicas, as long as they implement the same interface they can easily be grouped in CC or peer group modes. In the likely event the actual programmer interfaces are not identical, a single interface must be decided on by the system architect, and the service proxy can implement the interface and its translation to the actual programmer interface. Consider that the Calculator group desires to provide a multiplication function, and consider that Calc-1 natively provides the interface Mult (float x, float y) and returns the result of x multiplied by y, while Calc-2 provides the interface multiply_by (float x, float y, float z) and returns the result of x multiplied by y in the variable z. The system architect may decide that the Calculator interface will have syntax Multiply (float x, float y) and provide the result of x multiplied by y. Then the service proxy for Calc-1 will implement Multiply (x, y) as Mult (x, y), while the service proxy for Calc-2 will implement Multiply (x, y) as multiply_by (x, y, z), having previously declared its own local variable z, and then return the value z. To further the example, suppose Calc-3 supports 64-bit precision, but Multiply (x, y) provides for only 16-bit precision; then the service proxy for Calc-3 will need to truncate 48 bits. If a member of the group cannot perform all the functions defined in the common interface, then the service proxy will need to compensate, either by completing the functionality, or by returning an exception (provided exceptions are defined in the common interface). For instance, suppose Calc-4 provides only for addition. Then its service proxy could implement Multiply (x,y) as y additions of x to itself (for example: float result=0.0; for int i=1 to y, {result=add (x, result)}.

While in the preferred embodiment, the translations necessary to provide a common interface are handled by the service proxies, a similar function can be performed by the grouping agent for the service. Taking advantage of mobile code, another solution to this problem is to provide a special dedicated wrapper to the client or the service to handle this translation. Other solutions will be obvious to those skilled in the art, and are included within the scope of this invention. In an alternative embodiment services that do not present the same interface are grouped together.

The remainder of the discussion will describe the particular methodology used in the present embodiment for key functions such as starting a group, adding an additional service to a group, calling a grouped service and fail over. Both peer groups and CC groups are described. In the discussions that follows, a generic service will be called a Foo, which could be any functionality. A Foo could be a clock, a counter, a display driver, a traffic sensor, or a calculator. Further a reference to a service taking a particular action shall mean the service taking that action either directly, or, in the preferred embodiment, through its grouping agent.

### Coordinator Cohort Groups Details

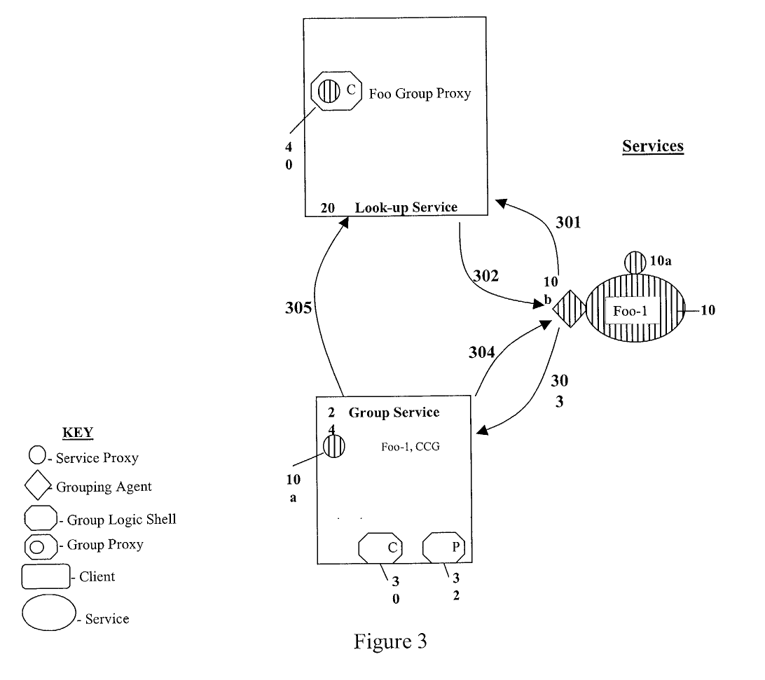

FIG. 3 shows how a new service joins a distributed application as an initial member of a CC group. In order to join a Foo group, Foo-1 10 (or its grouping agent 10b) queries the look-up service 20 to see if a group service is available 301. The group service 24 has already registered with the look-up service 20 and has given the look-up service 20 its own proxy (not shown). The look-up service 20 responds to Foo-1's (or its grouping agent's) request by providing it with the group service proxy 302. The Foo-1 grouping agent 10b uses the group service proxy to invoke a method specifying a group name to join (in this case the Foo group), possibly the group structure it desires to participate in, and provides the Foo-1 service proxy 10a to the group service 24, 303. Since Foo-1 10 is the first service requesting to be a member of the Foo group, the group service 24 must create the Foo group. Since, in this case, Foo-1 10 (or its grouping agent 10b) requested a CC group structure, the group service 24 requests that Foo-1 10 become the coordinator, or primary 304, and Foo-1 10 (or its grouping agent 10b) accepts. The group service 24 bundles the Foo-1 service proxy 10a with the CC Foo group logic shell 30 to form the Foo group proxy 40. The group service 24 then registers the Foo group service with the look-up service 20, which will be implemented as a CC group of member of Foo-x instances, and gives the look-up service 20 the Foo group proxy 40, 305. In the preferred embodiment, the look-up service 20 contains all information that is relevant to describing services. When Foo is implemented as a group, it might include this in the attributes it lists with the look-up service 20, as well as its group structure (CC or peer) to indicate its increased fault tolerance or to differentiate itself from any of the other registered services also named Foo.

Thus, Foo-1 10 provides the specific logic necessary for a client to call it (the Foo-1 service proxy 10a), and the group service 24 provides the group-aware logic necessary for a client to work with a CC group of Foos (the CC Foo group logic shell 30). When a client requests a Foo from the look-up service 20, the look-up service 20 provides the client the Foo group proxy 40 consisting of the service proxy for Foo-1 10a and a Foo group logic shell for CC groups 30. Note that the client does not request Foo-1, a specific group member, but simply requests a Foo service, which happens to be implemented as a CC group. Note also that the client may remain totally unaware of the existence of the group of Foos and the group service.

The type of group logic shell, peer or CC, provided by the group service is determined by the type of group the Foos are configured as. The grouping mode may be determined by request of the grouping agent of the service responsible for creating or joining a group (Foo- 1 in the example above) or by the group service itself. In addition, the mode may be determined by external events. For example, when network reliability is measured to drop below a certain threshold, the group may transition from CC to peer to ensure with higher probability that at least one member is always reachable.

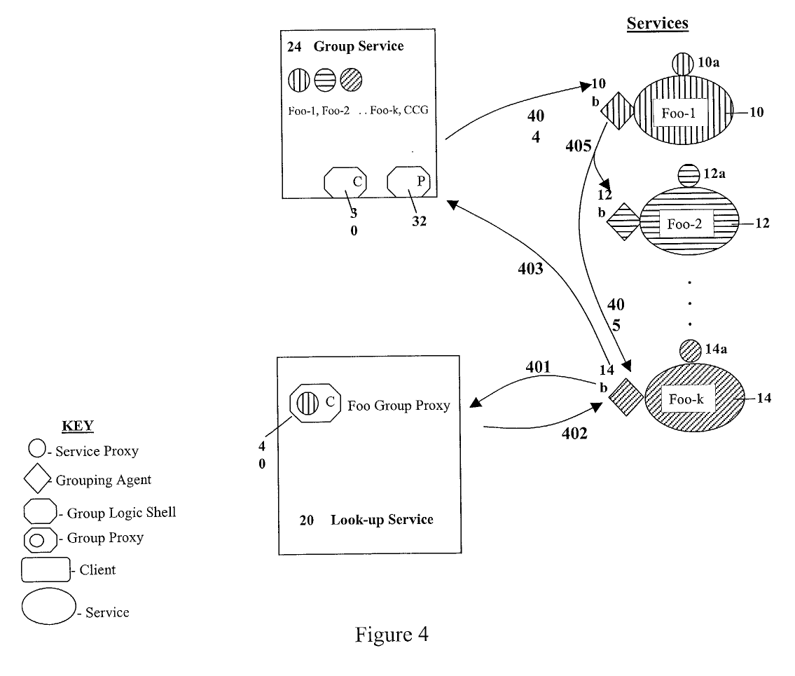

FIG. 4 shows how another instance of a Foo service, Foo-k 14, joins an existing CC Foo group. The first three steps are as described above for Foo-1 401, 402, 403. Then, since there already is an established coordinator for the Foo group (assuming it is still Foo-1), the group service 24 simply notifies the grouping agent 10b for the group coordinator 10 that there is a new member, or multiple new members, of the Foo group 404. The Foo- 1 grouping agent 10b then begins to include the Foo-k grouping agent 14b in its periodic broadcasts to all the other Foos of its current group 405. In an alternate embodiment, the grouping agents would be initially designed to listen for relevant update events, so that updates can be done without requiring the coordinator to be aware of its cohorts' identities. Analogously, when a cohort Foo service, Foo-j fails or is removed from the group, in the current embodiment, the coordinator must be informed by the group service; in the anonymous embodiment it would not need to be. Removal of a Foo service from the Foo group, other than a coordinator, is similar to adding a Foo service.

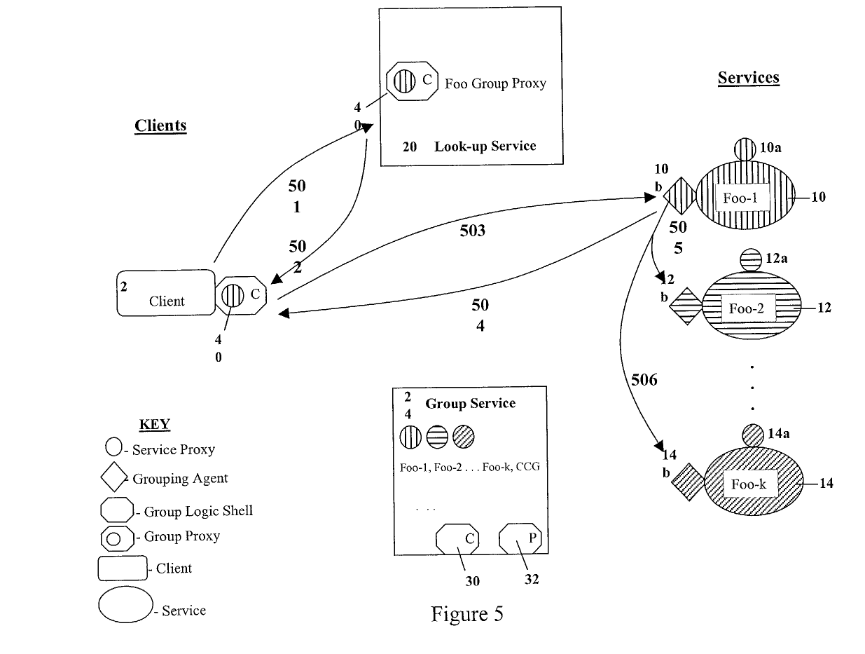

FIG. 5 shows a client 2 accessing a Foo service that is implemented as a CC group. First, the client 2 inquires with the look-up service 20 if there is a Foo 501. The look-up service responds by providing the Foo group proxy 40 (consisting of the Foo-1 service proxy 10a and the CC Foo group logic shell 30) registered by the group service 24, 502. Had the group service 24 designated Foo-k 14 as the leader, then the group proxy 40 would have included the Foo-k service proxy 14a instead of the Foo-1 proxy 10a.

The client 2 makes its calls to Foo-1 503 through the Foo group proxy 40. Within the Foo group proxy 40, the Foo-1 service proxy 10a has the specific methods and syntax necessary for any interaction with Foo-1, and the Foo group logic shell 30 provides the logic for interacting with the CC Foo group. The latter is necessary to handle failures and other group transitions, as will be described later, but during the normal operation commands pass directly from the client 2 (via the Foo-1 Service Proxy 10a) to Foo-1 10. Foo-1 10 may also provide return results to the client 504.

As Foo-1 10 performs its tasks for a client 2, it periodically updates the other Foo instances for any relevant state changes 505. For example, assuming the Foos were a group of cameras, Camera-1 may update the other cameras with its current angular position and zoom factor. Assuming that updates occur after completion of each command from a client, if Camera-1 fails while making a turn, Foo-k will not know the correct position when it takes over. Alternatively, Camera-1 might update the others cameras of its current position with each degree it turns, in which case when Camera-k should never be more than a degree out of position. Although Camera-k might not actually move while it is in back-up mode, as soon as it becomes the leader it can move to the last known position of Camera-1.

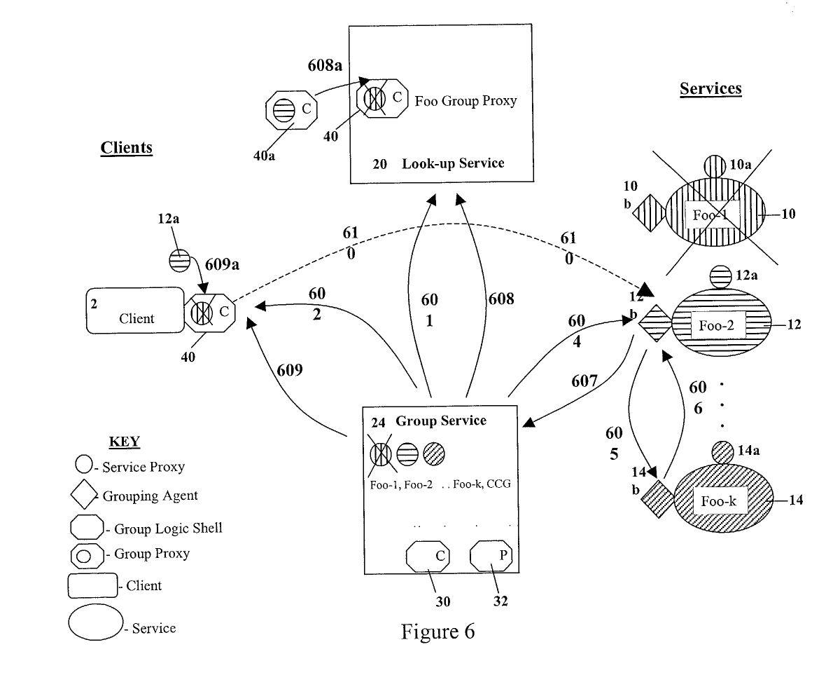

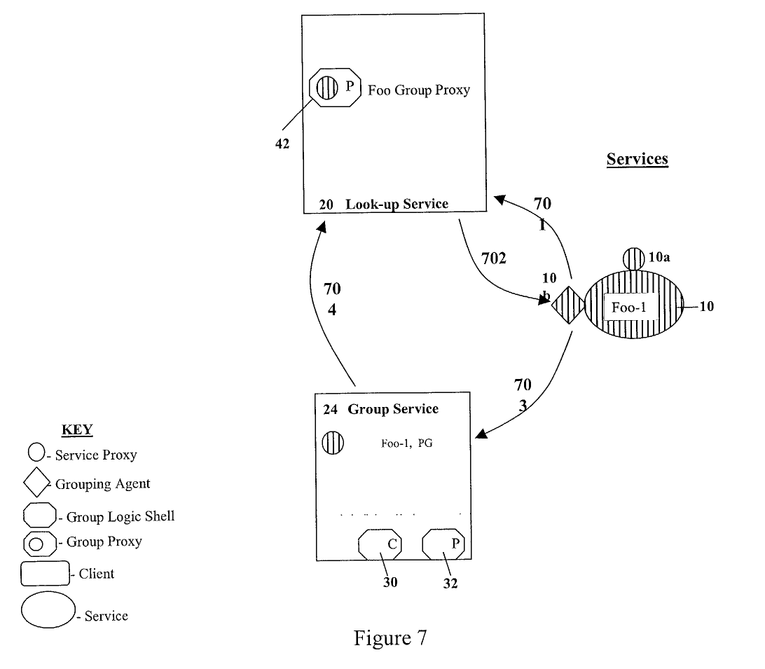

FIG. 6 is a description of how the invention handles a failover specifically, and transitions within a group generally. To begin, Foo-1 10 has a lease with the group service 24, where the group service 24 is the lease grantor and Foo-1 10 is the lease holder, and that the Foos are in CC mode. The group service 24 has in turn negotiated a lease for the grouped Foo service with the look-up service 20. Foo-1 10 fails and therefore does not renew its lease with the group service 24. The group service 24, assumes that Foo-1 10 has not renewed its lease because it has failed. The group service 24 then cancels the Foo lease with the look-up service 20, 601 thereby temporarily preventing any new client from finding the Foo group. The group service 24 also announces (whether through multicast, broadcast, or individual event notification) to the group proxy 40 using the Foo service that Foo is unavailable 602. The announcement may also be heard by other interested members of the distributed application, such a log service that records errors or a beeper service that notifies a human operator. These decisions are left to the system designer, but may be implemented the same way.

In this example there is a single client 2, but there may be multiple clients using the Foo group, in which case each client would have an instance of the Foo group proxy 40 and would be notified and updated by the group service. Likewise, the Foo group proxy 40 for each client would buffer that client's commands during any transitions.

While in the described embodiment a service detects a client's unavailability through leasing, any other method of detecting unavailability can be used. For example, a dedicated failure detection service may be employed to actively and interactively monitor the status of all system components. Many methods for detecting unavailability, whether performed by each service, or by a generic failure detection service are known to those skilled in the art, and all such methods, as well as any others later invented, are included within the scope of this invention.

Similarly, while in the described embodiment the group service announces the notification of the Foo-1 10 failure, essentially combining the functions of failure detection, failure announcement and group organization, the system can be designed to separate these functions; specifically, a failure detection service could announce failures to clients and to the group service, or it could pass detections on to an announcement service.

Continuing in FIG. 6, upon notification of the unavailability of Foo, the group proxy 40 begins to buffer commands to Foo from the client 2 it represents. The group service 24 then requests 604 that another Foo service, in this case Foo-2 12, become the coordinator of the group and synchronize its state with the remaining Foos 605, 606. The state synchronization is handled by the grouping agent 10b, 12b, 14b for each of the services 10, 12, 14. Depending on the degree of assurance of synchronization required, this can be done anonymously through event notification (low degree of assurance) or explicitly through tightly-coupled individual method invocations (high degree of assurance). Foo-2 12 becomes the coordinator and then acknowledges the group service 24, 607. The group service 24 registers Foo-2 12 as the Foo service with the look-up service 20, 608, preferably by providing the look-up service 20 with a new Foo group proxy 40a, 608a containing the same group logic shell 30, but now with the Foo-2 service proxy 12a. Alternatively, if the look-up service 20 is capable of modifying registered proxies, the group service 24 can provide the look-up service 20 with the Foo-2 service proxy 12a to update the Foo group proxy 40 with (but leaving the existing group logic shell 30 in place). The group service 24 then distributes the Foo-2 service proxy 12a to the clients' group proxies (only one shown) 609. The group proxy 40 deletes the Foo-1 service proxy 10a and add the Foo-2 service 609a proxy 12b, 609a. The group service 24 then announces (not shown) to all the group proxies that the Foo service is again available. Note that steps 608 and 609 can be executed in either order or concurrently. Using the Foo-2 service proxy 12a the group proxy 40 directs the buffered commands to Foo-2 610. Once all buffered command have been sent, the client 2 commands can again be sent directly.

Client 2 commands may be redirected and/or buffered for other reasons than the failure of a service. The same methodology can be used to help manage the performance of the service, by smoothing or evening out the load on the service, or to restructure the group from a CC group to a peer group. Such applications might be useful for testing a new service in parallel with an existing service.

### Peer Group Details

A similar process is used to operate a group in peer group mode, however a more complex grouping agent is required. In particular, the service proxies of all of the members of a peer group, must be used in sending out requests because when organized as a peer group, each member receives and responds to all clients' requests made to that service group. Thus, if the Calculator group was composed of Calc-1, Calc-2, Calc-3, and Calc-4, each would receive a client's invocation of Multiply (4, 5) and each would return to the client its own response to the invocation.

FIG. 7 shows how a new service joins a distributed application as an initial member of a peer group. The process is very similar to that described in FIG. 3. In order to join a Foo group, Foo-1 10 (or its grouping agent 10a) queries the look-up service 20 to see if a group service 24 is available 701. The group service 24 has already registered with the look-up service and has given the look-up service 20 its own proxy (not shown). The look-up service 20 responds to Foo-1 's 10 (or its grouping agent's 10b) request by providing it with the group service proxy 702. The Foo-1 grouping agent 10b uses the group service proxy to invoke a method specifying a group name to join (in this case the Foo group), possibly the group structure it desires to participate in, and provides the Foo-1 service proxy 10a to the group service 703. Since Foo-1 10 is the first service requesting to be a member of the Foo group, the group service 24 must create the Foo group. Since, in this case, Foo-1 10 (or its grouping agent 10b) requested a peer group structure the group service 24 does not need to designate any Foo as the coordinator (as was necessary for a CC group). The group service bundles the Foo-1 service proxy 10a with the peer Foo group logic shell 32 to form the Foo group proxy 42. The group service then registers the Foo group with the lookup service 20, which will be implemented as a peer group of Foo-x instances 704 and gives the look-up service 20 the Foo group proxy 42. Thus, Foo-1 10 provides the specific logic necessary for a client to call it (the Foo-1 service proxy 10a), and the group service 24 provides the group-aware logic necessary for the client to work with a peer group of Foos (the peer group logic shell 42).

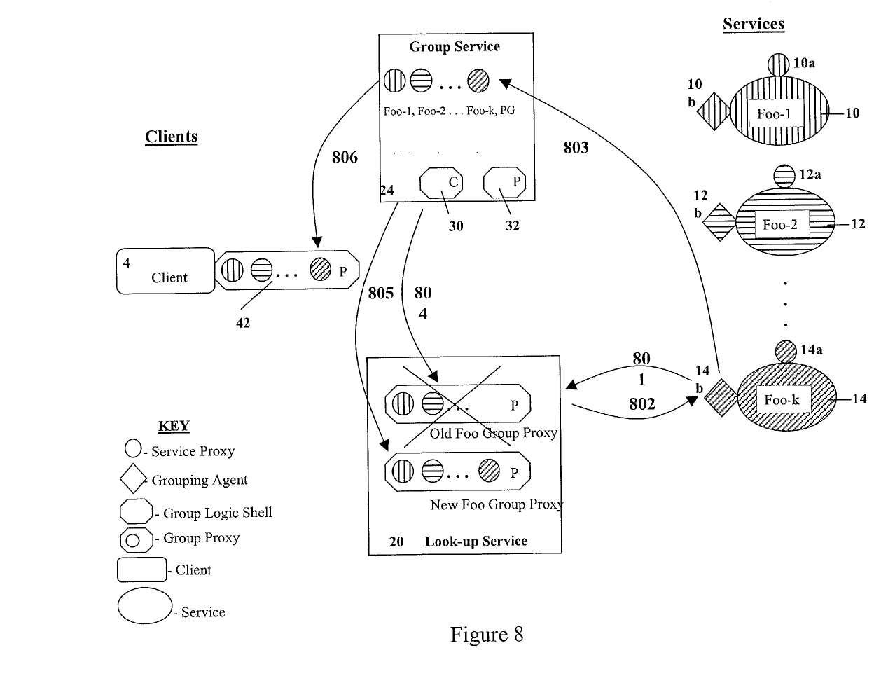

FIG. 8 shows how another instance of a Foo service, Foo-k 14, joins an existing peer Foo group. The first three steps are as described above for Foo-1 in FIG. 7 801, 802, 803. Continuing, the group service 24 deregisters Foo from the look-up service 20 so that outdated Foo proxies 10a, 12a are no longer distributed 804. The group service adds the Foo-k service proxy 14a to the existing set of proxies for Foo members, adding the Foo-k service proxy 14a to the peer Foo group logic shell 32, and re-registers Foo with the look-up service 20, 805. The group service 24 then distributes Foo-k's proxy 14a to all peer Foo group proxies already attached to clients, which add it to the bundle of other Foo member proxies already within the Foo group logic shell 806. Future client requests are therefore sent to Foo-k as well as all previous Foo group members. Steps 805 and 806 can be executed in either order or concurrently. The group service 24 might also instruct the group proxy for the clients to buffer commands until they receive the Foo-k proxy 42. However, in contrast with a CC group transition, there is no need for group proxies of peer groups to await further information about the peer group transition, so that there is no need for peer group proxies to buffer client commands.

To remove Foo-j from a peer Foo group, the group service 24 distributes instructions to the Foo peer group proxies 42 (already attached to clients 2) to remove the Foo-j service proxy from each of the Foo peer group logic shells 32. As in steps 804 and 805 above, the group service unregisters then re-registers Foo with the look-up service, and, as above, the group proxy 42 at the look-up service 20 and clients 2 can be updated in either order or concurrently.

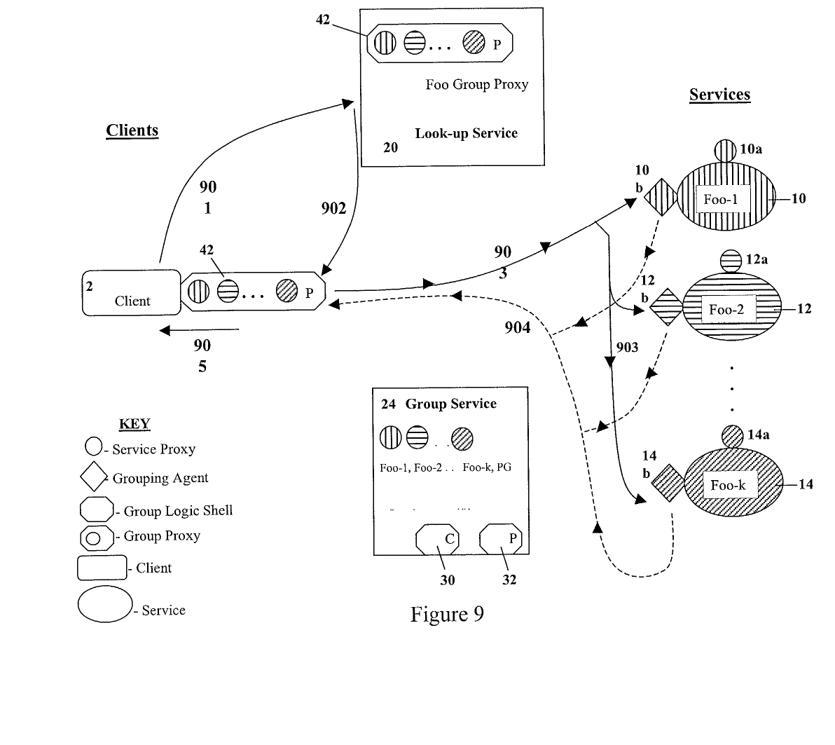

FIG. 9 shows a client 2 accessing a Foo service that is implemented by a peer group. First, the client 2 inquires with the look-up service 20 if there is a Foo 901. The look-up service 20 responds by providing the Foo group proxy 42, which includes the service proxies 10a, 12a, 14a for all Foos in the group bundled within the peer Foo group logic shell 32, 902. The group proxy 34 implementing the peer group-aware logic is, like the CC group-aware proxy, the initial pass-through for client invocations. It invokes the appropriate method using the service proxies 10a, 12a, 14a of all the services in the Foo group 10, 12, 14, 903. All of the Foo services 10, 12, 14 in the group execute the client's 2 command and return a response 904. In this embodiment, the Foo group proxy 42 (using the peer Foo group logic shell 32) also implements the strategy for handling the plurality of responses back from the numerous Foo members and returns a single response to the client 905. For example, it may accept the first response or average all responses. In an alternative embodiment, the grouping agents 10b, 12b, 14b for the Foos might coordinate with each other and return a single response back to the Foo group proxy 42 at the client 2.

The handling of a failure of one of the services in a peer group is relatively trivial. The failure might be detected when a failed Foo service does not renew its lease with the group service, or when the client's group proxy detects that a failed Foo did not provide a response to an invocation and then notifies the group service 24. The failed Foo's service proxy is simply removed from the peer group proxy shells at the clients 2 and the look-up service 20 bundle as described above with respect to FIG. 8. In a peer group configuration, the transition period is much short than for a CC group, so buffering may not be needed.

As in the case of the CC groups, while the details of the peer group have been described with a single client, it is equally applicable to an application with multiple clients, where each client has a replica of one or more group proxies. The group service notifies and updates the group proxies at each of the clients and each group proxy buffers commands for the client it is attached to.

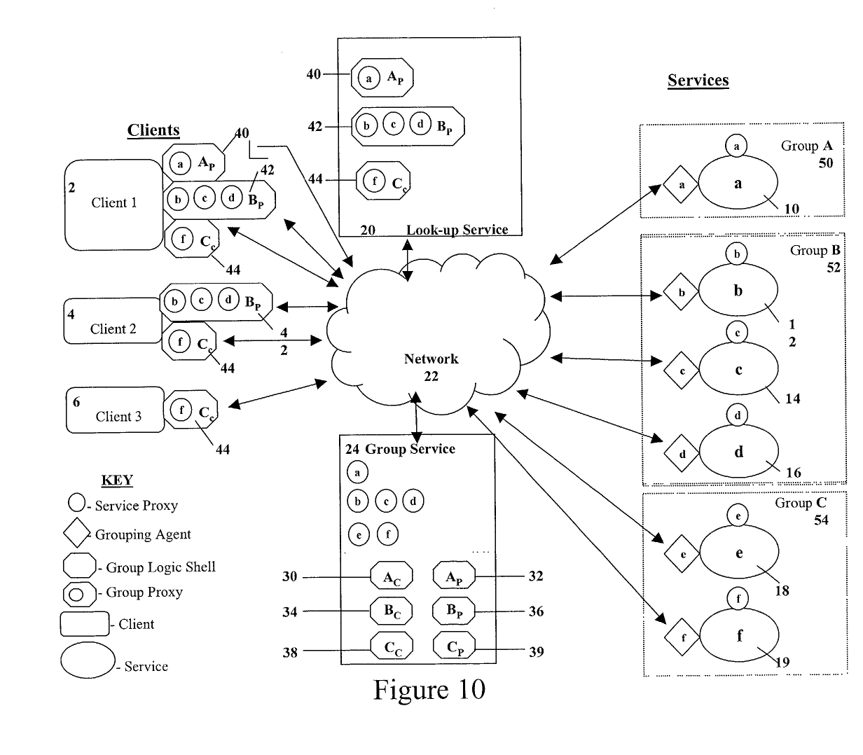

The invention is not meant to be limited to the particular application or number of services, groups and clients shown in FIG. 2. FIG. 10 shows a generic implementation of the present invention in which there are three clients 2, 4, 6 and three different groups of services 50, 52, 54, although there need not always be an equal number of clients and groups. In this representation groups are represented in capital letters and services in small letters. For each group 50, 52, 54 the group service 24 has a CC group logic shell 30, 34, 38 (indicated by a subscript “c”) and a peer group logic shell 32, 36, 39 (indicated by a subscript “p”). One point of this representation is to demonstrate that a client can call multiple groups, and a single group can be called by multiple clients, provided that each client 2, 4, 6 has the appropriate group proxy 40, 42, 44. For instance one client 2 calls all three groups: A 50, B 52, and C 54. Likewise, one group, C 54, is used by all three clients 2, 4, 6, and therefore each client has the group proxy 40, 42, 44 for that group. Also, in this representation there is a group, group A 50, consisting of only one service, thereby allowing the client of a single service to obtain some of the benefits of the group proxy, such as failure masking by buffering. In this embodiment, as presently shown, group A 50 and group B 52 are peer groups, and group C 54 is a CC group, although the structure of each group can be reconfigured.

While this description has principally referred to two types of groups, peer and coordinator cohort, hybrids of these types, and other types of modes are possible, and the invention is meant to incorporate all such groups, whether currently existing or invented hereafter. It has also been assumed herein that a grouping agent contains all the necessary logic to act in either CC or peer mode. However in an alternative embodiment, a service may have separate grouping agents for CC and peer modes. Likewise, although not optimal for reasons discussed above, a service could be written to incorporate the grouping agent functions, without having a separate group proxy.

A group service is not necessary to gain the client-side benefits of command buffering using a group proxy. As described, the group service performs both failure detection and group management. In the absence of true groups, but given a mechanism for detecting failures, the “group” proxy could buffer requests upon being notified of a failure. Upon noticing that the service had been reestablished (for example, by periodically querying the look-up service) this group proxy would resume normal operation. This provides for less overall reliability (the existence of a group of replicas is proportionately more reliable) and increased latency (the duration between the service failing and being restarted) but still shields clients from the effects of service failures or transitions. In the preferred embodiment for implementing fault tolerance, the distributed system will implement true replication of services, and therefore will have a group service.

It is also possible, in an alternative embodiment to combine the group service and lookup services into a single service. Likewise, in an alternative embodiment, the group logic shell, instead of being stored in the group service could be provided by the system designer ahead of time to each client that will need a particular group, and then the group service simply provides and updates the appropriate service proxies in those group logic shells. Such an architecture is less desirable in that it is less flexible, since it requires prior knowledge for each client, that it will use a group and which groups a service will be using.

It is understood that the invention is not limited to the disclosed embodiments, but on the contrary, is intended to cover various modifications and equivalent arrangements included within the spirit and scope of the appended claims. Without further elaboration, the foregoing will so fully illustrate the invention, that others may by current or future knowledge, readily adapt the same for use under the various conditions of service.

What is claimed is:

1. A mobile group proxy for use by a client to call a group of services in a distributed computing application comprised of:
a mobile group shell code module containing logic to interact with the group; and
at least one mobile service proxy code module containing logic for the client to interact with one of the services in the group.

2. The mobile group proxy described in claim 1 wherein the mobile group proxy is created while the application is executing.

3. The mobile group proxy described in claim 1 wherein the mobile group proxy can be modified while the application is executing.

4. The mobile group proxy described in claim 1 wherein the group proxy is able to buffer commands from the client to the group of services when the group is not available.

5. A method of creating a group proxy for use by a client to call a group of services in a distributed computing application comprising the steps of:
selecting a group logic shell for the group;
selecting at least one service proxy for a service within the group; and
combining the group logic shell with the at least one service proxy.

6. The method of claim 5 wherein the group logic shell is selected based upon the type of group structure desired.

7. The method of claim 6 wherein the group structure is peer or coordinator cohort.

8. The method of claim 5 wherein the steps of claim 5 are repeated to create a plurality of group proxies for a plurality of groups of services.

9. The method of claim 5 wherein the steps are performed while the application is executing.

10. The method of claim 5 wherein the group logic shell and the at least one service proxy are mobile and the resulting group proxy is mobile.

11. The method of claim 5 further comprising the step of the group proxy buffering commands from the client to the group when the group is not available.

12. A computer readable medium containing instructions for controlling a computer system to perform a method of creating a group proxy for a group of services in a distributed computing application, the method comprising:
selecting a group logic shell for the group;
selecting at least one service proxy for a service within the group; and
combining the group logic shell with the at least one service proxy.

13. The computer readable medium of claim 12 wherein the group logic shell is selected based upon the type of group structure desired.

14. The computer readable medium of claim 13 wherein the group structure is peer or coordinator cohort.

15. The computer readable medium of claim 12 wherein the steps of claim 12 are repeated to create a plurality of group proxies for a plurality of groups of services.

16. The computer readable medium of claim 12 wherein the steps are performed while the application is executing.

17. The computer readable medium of claim 12 wherein the group logic shell and the at least one service proxy are mobile and the resulting group proxy is mobile.

18. The computer readable medium of claim 12 wherein the method is further comprised of the step of the group proxy buffering commands from the client to the group when the group is not available.

19. A distributed computing system comprising:
a plurality of computing devices;
a plurality of services, operating on at least one of the computing devices, arranged into a group;
a client, operating on at least one of the computing devices, that calls the group to perform a task;
a group proxy, operating on at least one of the computing devices, used by the client to communicate with the group;
a group service, operating on at least one of the computing devices, that creates and updates the group proxy; and
a communication network allowing the services and client to communicate with each other across the computing devices.

20. The system described in claim 19 wherein the group is a peer group or coordinator cohort group.

21. The system described in claim 19 further comprised of additional services arranged into at least one additional group.

22. The system described in claim 21 wherein at least one of the groups is comprised of a single service.

23. The system describe in claim 21 wherein all the services in each group perform the same task.

24. The system described in claim 21 further comprising a group proxy for each group.

25. The system described in claim 19 further comprising a grouping agent, operating on at least one of the computing devices, which communicates on behalf of at least one service within the group, with the group service and other services within the group.

26. The system described in claim 25 further comprising a dedicated grouping agent for each service that is a member of the group.

27. The system described in claim 19 wherein the plurality of computing devices are virtual machines within a general purpose computer.

28. The system described in claim 19 further comprising a look-up service, operating on at least one of the computing devices, that lists the group and some of the other services available in the system.

29. The system described in claim 28 wherein the look-up service and the group service are combined into a single service.

30. The system described in claim 19 further comprising a plurality of clients.

31. The system described in claim 19 wherein the group proxy is further comprised of a group logic shell and at least one service proxy.

32. The system described in claim 19 wherein the group proxy is mobile.

33. The system described in claim 19 wherein the group proxy is capable of buffering commands from the client to the group when the group is not available.

34. A distributed computing system comprising:
a plurality of computing devices;
a plurality of services, operating on at least one of the computing devices, arranged into a plurality of groups, with each of these services having an associated service proxy, operating on at least one of the computing devices, said service proxy used to call its associated service;
a plurality of clients, operating on at least one of the computing devices, that call the groups to perform tasks;
a plurality of group proxies, each group proxy being associated with a group, operating on at least one of the computing devices, and being used by a client to communicate with its associated group, and each group proxy being comprised of:
a group logic shell containing the logic necessary to communicate with the associated group; and
at least one of the service proxies associated with a service within the associated group;
a group service, operating on at least one of the computing devices, that creates and updates the group proxy;
a plurality of grouping agents, each grouping agent being associated with a grouped service, operating on at least one of the computing devices, and communicating on behalf of its associated service with the group service and other services within its group; and
a communication network allowing the computing devices to communicate with each other.

35. The system described in claim 34 wherein the groups are peer groups or coordinator cohort groups.

36. The system described in claim 34 wherein at least one of the groups is comprised of a single service.

37. The system described in claim 34 wherein all the services in each group perform the same task.

38. The system described in claim 34 wherein the plurality of computing devices are virtual machines within a general purpose computer.

39. The system described in claim 34 further comprising a look-up service, operating on at least one of the computing devices, that lists some of the other services and groups available in the system.

40. The system described in claim 39 wherein the look-up service and the group service are combined into a single service.

41. The system described in claim 34 wherein the group proxies are mobile.

42. The system described in claim 34 wherein the group proxy are capable of buffering commands from the client to the group when the group is not available.

43. A method of grouping services in a distributed computing application comprising the steps of:
initiating a plurality of services arranged into a group, with each service having its own service proxy and grouping agent;
each grouping agent registering its associated service with a group service including providing the group service with the service proxy of the service it is registering;
the group service bundling a group logic shell with at least one of the service proxies to form a group proxy for the group;
the group service providing the group proxy to a client; and
the client using the group proxy to call the group.

44. The method described in claim 43 wherein the group is a peer group or a coordinator cohort group.

45. The method described in claim 43 wherein the services are arranged into a plurality of groups, there is a group logic shell for each group and the group service creates a group proxy for each group.

46. The method described in claim 43 wherein the group service provides the group proxy to the client by registering the group proxy with a look-up service.

47. The method described in claim 43 further comprising the step of the group proxy buffering commands from the client to the group.

48. A computer readable medium containing instructions for controlling a computer system to perform a method of grouping services in a distributed computing application, the method comprising the steps of:
initiating a plurality of services arranged into a group, with each service having its own service proxy and grouping agent;
associating each service in the group with its own grouping agent;
each grouping agent registering its associated service with a group service including providing the group service with the service proxy of the service it is registering;
the group service bundling a group logic shell with at least one of the service proxies to form a group proxy for the group;
the group service providing the group proxy to a client; and
the client using the group proxy to call the group.

49. The computer readable medium of claim 48 wherein the group is a peer group or a coordinator cohort group.

50. The computer readable medium of claim 48 wherein the services are arranged into a plurality of groups, there is a group logic shell for each group and the group service creates a unique group proxy for each group.

51. The computer readable medium of claim 48 wherein the group service provides the group proxy to the client by registering the group proxy with a look-up service.

52. The computer readable medium of claim 48 wherein the method is further comprised of the step of the group proxy buffering commands from the client to the group.

53. A distributed computing system comprising:
a plurality of computing devices;
a service operating on at least one of the computing devices;
a client, operating on at least one of the computing devices, that requests the first service to perform a task;
a mobile group proxy associated with the service for handling communication between the client and the first service and able to buffer commands from the client to the first service when the first service is not available; and
a communication network allowing the service and the client to communicate with each other across the computing devices.

54. The system described in claim 53 wherein the plurality of computing devices are virtual machines within a general purpose computer.

55. The system described in claim 53 further comprising a plurality of services arranged into at least one group.

56. The system described in claim 53 wherein the group proxy is able to buffer commands from the client to the service when the first service is not available.

57. The system described in claim 53 further comprising a look-up service, operating on at least one of the computing devices, that lists the service.
